(19) United States
(12) Patent Application Publication
(10) Pub. No.: US 2019/0286163 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Naoto Yasuda, Wako-shi (JP); Takafumi Hirose, Wako-shi (JP); Yuki Oshitani, Tokyo (JP); Susumu Iwamoto, Tokyo (JP)

(21) Appl. No.: 16/260,177

(22) Filed: Jan. 29, 2019

(30) Foreign Application Priority Data
Mar. 13, 2018 (JP) 2018-045906

(51) Int. Cl. G05D 1/02; G05D 1/00; G08G 1/00; B60W 30/16

(52) U.S. Cl. CPC G05D 1/0293; G05D 1/0088; G05D 2201/0213; B60W 30/16; G08G 1/22

(57) ABSTRACT

An automatic driving control device (100) includes a recognition unit (130) which recognizes a peripheral situation of an automatic driving vehicle, and driving control units (120 and 160) which automatically control acceleration/deceleration and steering of the automatic driving vehicle on the basis of the peripheral situation recognized by the recognition unit, performs control such that a host vehicle and the other vehicles perform platooning on the basis of a result of the communication with other vehicles, selects one or more vehicles satisfying a first condition as a preceding vehicle among platooning vehicles, and determines that the one or more vehicles separately travel as the preceding vehicle preceding the platooning vehicles by a distance larger than an inter-vehicle distance between the platooning vehicles.

### CROSS-REFERENCE TO RELATED APPLICATION

This application claims priority based on Japanese Patent Application No. 2018-045906 filed in Japan on Mar. 13, 2018, the entire content of which is incorporated herein by reference.

### BACKGROUND

### Field of the Invention

The present invention relates to a vehicle control device, a vehicle control method, and a storage medium.

### Background

Studies on platooning in which a plurality of vehicles travel on the same lane in a row are underway (for example, Japanese Unexamined Patent Application, First Publication No. 2017-215681).

### SUMMARY

In recent years, studies on automatic driving have been actively performed, and it is expected that vehicles that travel unmanned will also appear in the future. However, in the conventional technology, no consideration has been given to applicable platooning in accordance with future driving scenes.

The present invention has been made in view of such circumstances, and an object thereof is to provide a vehicle control device, a vehicle control method, and a storage medium that can realize more applicable platooning.

A vehicle control device, a vehicle control method, and a storage medium according to this invention have adopted the following configuration.

(1): A vehicle control device according to one aspect of the present invention includes a communication unit that communicates with other vehicles and a platooning control unit that performs control such that a host vehicle and the other vehicles perform platooning on the basis of a result of the communication with the other vehicles by the communication unit and further includes a determination unit that selects one or more vehicles satisfying a first condition as a preceding vehicle among platooning vehicles, and determines that the one or more vehicles separately travel as the preceding vehicle preceding the platooning vehicles by a distance larger than an inter-vehicle distance between the platooning vehicles.

(2): In the aspect (1) described above, the first condition is that a vehicle is an unmanned automatic driving vehicle.

(3): In the aspect (1) described above, the first condition is that a vehicle has a higher external recognition performance than a reference.

(4): In the aspect (1) described above, when the preceding vehicle satisfies a second condition, the determination unit determines a second preceding vehicle to replace the preceding vehicle as a next preceding vehicle among the platooning vehicles.

(5): In the aspect (4) described above, the second condition includes that a predetermined time has elapsed since the preceding vehicle started traveling as the preceding vehicle or that the preceding vehicle has traveled a predetermined distance or more since it started traveling as the preceding vehicle.

(6): In the aspect (1) described above, the determination unit determines each inter-vehicle distance between the platooning vehicles on the basis of whether an occupant is present in each of the platooning vehicles among the platooning vehicles.

(7): In the aspect (1) described above, the determination unit determines a deceleration of each of the platooning vehicles on the basis of whether an occupant is present in each of the platooning vehicles among the platooning vehicles.

(8): In the aspect (1) described above, the determination unit selects one or more vehicles satisfying a third condition among the platooning vehicles on the basis of a result of communicating with the other vehicles using the communication unit, determines that the one or more vehicles become a following vehicle following the platooning vehicles by a distance larger than the inter-vehicle distance between the platooning vehicles, and notifies the other vehicles of a result of the determination using the communication unit.

(9): In the aspect (8) described above, when a lane on which all the platooning vehicles travel is changed, the determination unit determines to perform a lane change from the following vehicle.

(10): In the aspect of (8) described above, the third condition is that a vehicle is an unmanned automatic driving vehicle.

(11): In the aspect of (8) described above, the third condition is that a vehicle has a higher external recognition performance than a reference.

(12): In the aspect (8) described above, when the following vehicle satisfies a fourth condition, the determination unit determines a second following vehicle to replace the following vehicle as a next following vehicle among the platooning vehicles.

(13): In the aspect (12) described above, the fourth condition is that a predetermined time has elapsed since the following vehicle started traveling as the following vehicle or that the following vehicle has traveled a predetermined distance or more since the following vehicle started traveling as the following vehicle.

(14): A vehicle control method of a computer according to another aspect of the present invention is a vehicle control method executed by a computer installed in a vehicle, and includes communicating with other vehicles, determining that a plurality of the other vehicles are dividedly travel as platooning vehicles and a preceding vehicle preceding the platooning vehicles by a distance larger than an inter-vehicle distance between the platooning vehicles on the basis of a result of communicating with the other vehicles, and controlling traveling of the platooning vehicles.

(15): A computer readable non-transitory storage medium in which a program is stored according to still another aspect of the present invention causes a computer to communicate with other vehicles, determine that a plurality of the other vehicles are separated and travel as platooning vehicles and a preceding vehicle preceding the platooning vehicles by a distance larger than an inter-vehicle distance between the platooning vehicles on the basis of a result of communicating with the other vehicles, and control traveling of the platooning vehicles.

According to (1) to (15), more applicable platooning can be realized.

### BRIEF DESCRIPTION OF THE DRAWINGS

FIG. 1 is a diagram which shows a configuration of a vehicle system.

FIG. 2 is a functional configuration diagram of an automatic driving control device according to a first embodiment.

FIG. 3 is a diagram which shows an example of a positional relationship between extended platooning vehicles.

FIG. 4 is a flowchart which shows a part of a flow of processing of starting extended platooning using a platooning control unit and a preceding vehicle determination unit.

FIG. 5 is a flowchart which shows a part of the flow of the processing of starting extended platooning using the platooning control unit and a platooning vehicle determination unit.

FIG. 6 is a flowchart which shows a part of a flow of processing of replacing a preceding vehicle using the platooning control unit and the preceding vehicle determination unit.

FIG. 7 is a diagram which shows another example of the positional relationship between extended platooning vehicles.

FIG. 8 is a functional configuration diagram of an automatic driving control device according to a second embodiment.

FIG. 9 is a flowchart which shows another part of the flow of the processing of starting extended platooning using the platooning control unit and a following vehicle determination unit.

FIG. 10 is a flowchart which shows a part of a flow of processing by which extended platooning vehicles perform avoidance by a steering operation using the platooning control unit.

FIG. 11 is a flowchart which shows a part of a flow of processing of replacing a following vehicle using the platooning control unit and the following vehicle determination unit.

FIG. 12 is a diagram which shows an example of a hardware configuration of the automatic driving control device according to the embodiment.

### DETAILED DESCRIPTION OF THE INVENTION

Hereinafter, embodiments of a vehicle control device, a vehicle control method, and a storage medium of the present invention will be described with reference to the drawings.

### First Embodiment

[Overall Configuration]

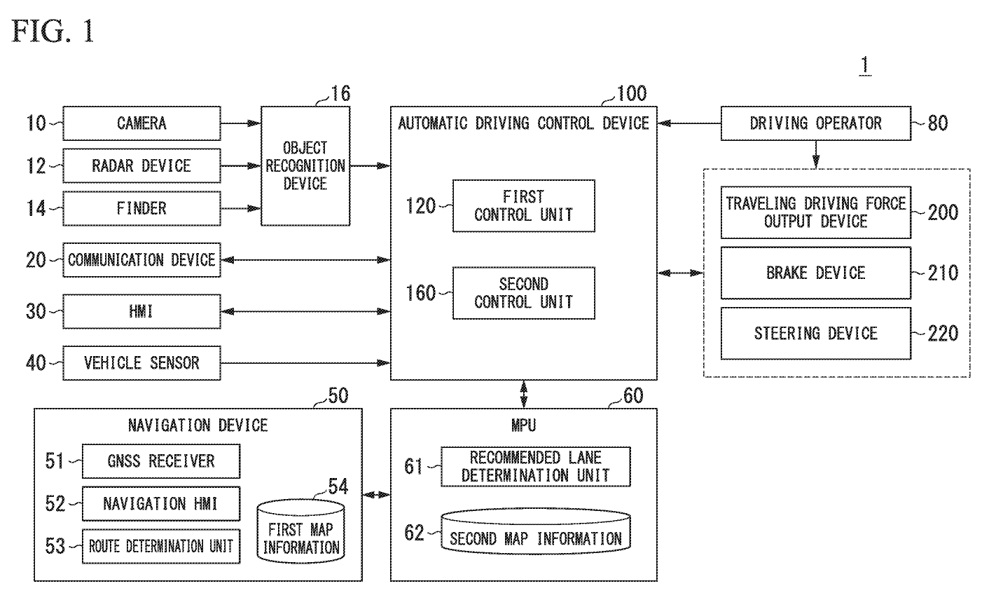

FIG. 1 is a configuration diagram of a vehicle system 1 using a vehicle control device according to an embodiment. A vehicle on which the vehicle system 1 is mounted is, for example, a two-wheeled vehicle, a three-wheeled vehicle, a four-wheeled vehicle, or the like, and the driving source is an internal combustion engine such as a diesel engine or a gasoline engine, an electric motor, or a combination of these. The electric motor operates using electric power generated by a generator connected to an internal combustion engine, or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automatic driving control device 100, a traveling driving force output device 200, a brake device 210, and a steering device 220. These devices and devicees are connected to each other by a multiplex communication line such as a controller area network (CAN) communication line, a serial communication line, a wireless communication network, or the like. The configuration shown in FIG. 1 is merely an example, and a part of the configuration may be omitted, or other constituents may be added.

The camera 10 is, for example, a digital camera using a solid-state imaging device such as a charge coupled device (CCD) or a complementary metal oxide semiconductor (CMOS). The camera 10 is attached to an arbitrary position of a vehicle (hereinafter, referred to as a vehicle M) on which the vehicle system 1 is mounted. In a case of imaging the side in front, the camera 10 is attached to an upper portion of the front windshield, a rear surface of the rearview mirror, or the like. The camera 10 repeatedly images the surroundings of the vehicle M periodically, for example. The camera 10 may also be a stereo camera.

The radar device 12 emits radio waves such as millimeter waves around the vehicle M, and detects radio waves (reflected waves) reflected by an object to detect at least a position (a distance to and an orientation) of the object. The radar device 12 is attached to an arbitrary position of the vehicle M. The radar device 12 may detect a position and a speed of an object using a frequency modulated continuous wave (FM-CW) method.

The finder 14 is a light detection and ranging (LIDAR) device. The finder 14 emits light around the vehicle M and measures scattered light. The finder 14 detects a distance to an object on the basis of time from light emission to light reception. The emitted light is, for example, laser light in a pulse form. The finder 14 is attached to an arbitrary position of the vehicle M.

The object recognition device 16 recognizes a position, a type, a speed, and the like of an object by performing sensor fusion processing on detection results using some or all of the camera 10, the radar device 12, and the finder 14. The object recognition device 16 outputs a result of the recognition to the automatic driving control device 100. The object recognition device 16 may output results of the detection by the camera 10, the radar device 12, and the finder 14 to the automatic driving control device 100 as they are. The object recognition device 16 may also be omitted from the vehicle system 1.

The communication device 20 communicates with other vehicles present around the vehicle M using, for example, a cellular network, a Wi-Fi network, Bluetooth (registered trademark), dedicated short range communication (DSRC), or the like, or communicates with various types of server devices via a radio base station. The communication device 20 is an example of a “communication unit.”

The HMI 30 presents various types of information to an occupant of the vehicle M, and receives an input operation of the occupant. The HMI 30 includes various types of display devices, speakers, buzzers, touch panels, switches, keys, and the like. The vehicle sensor 40 includes a vehicle speed sensor that detects a speed of the vehicle M, an acceleration sensor that detects an acceleration, a yaw rate sensor that detects an angular speed around the vertical axis, an orientation sensor that detects a direction of the vehicle M, and the like.

The navigation device 50 includes, for example, a global navigation satellite system (GNSS) receiver 51, a navigation HMI 52, and a route determination unit 53. The navigation device 50 holds first map information 54 in a storage device such as a hard disk drive (HDD) or a flash memory. The GNSS receiver 51 identifies a position of the vehicle M on the basis of a signal received from a GNSS satellite. The position of the vehicle M may be identified or supplemented according to an inertial navigation system (INS) using an output of the vehicle sensor 40. The navigation HMI 52 includes a display device, a speaker, a touch panel, a key, and the like. The navigation HMI 52 may be partly or entirely used in common with the HMI 30 described above. The route determination unit 53 determines a route from a position of the vehicle M identified by the GNSS receiver 51 (or an arbitrary input position) to a destination input by the occupant using the navigation HMI 52 (hereinafter, a route on a map) with reference to the first map information 54, for example. The first map information 54 is information in which a road shape is expressed by, for example, a link indicating a road and a node connected by a link. The first map information 54 may include information on curvature of a road, a point of interest (POI), and the like. The route on a map is output to the MPU 60. The navigation device 50 may perform route guidance using the navigation HMI 52 on the basis of the route on a map. The navigation device 50 may be realized by, for example, a function of a terminal device such as a smart phone or a tablet terminal held by an occupant. The navigation device 50 may transmit a current position and a destination to a navigation server via the communication device 20, and acquire the same route as the route on a map from a navigation server.

The MPU 60 includes, for example, a recommended lane determination unit 61, and holds second map information 62 in a storage device such as an HDD or a flash memory. The recommended lane determination unit 61 divides the route on a map provided from the navigation device 50 into a plurality of blocks (for example, divides every 100 [m] in a vehicle traveling direction), and determines a recommended lane for each block with reference to the second map information 62. The recommended lane determination unit 61 determines on which lane from the left to travel. The recommended lane determination unit 61 determines a recommended lane such that the vehicle M can travel along a reasonable route to proceed to a branch destination when there is a branch point on the route on a map.

The second map information 62 is map information with higher accuracy than the first map information 54. The second map information 62 includes, for example, information on a center of a lane, information on a boundary of the lane, or the like. The second map information 62 may include road information, traffic regulations information, address information (address/zip code), facility information, telephone number information, and the like. The second map information 62 may be updated at any time by the communication device 20 communicating with other devices.

The driving operator 80 includes, for example, an accelerator pedal, a brake pedal, a shift lever, a steering wheel, a variant steer, a joystick, and other operators. The driving operator 80 is attached to a sensor that detects an operation amount, or the presence or absence of an operation, and a detection result of the sensor is output to the automatic driving control device 100, or some or all of the traveling driving force output device 200, the brake device 210, and the steering device 220.

The automatic driving control device 100 includes, for example, a first control unit 120, and a second control unit 160. Each of the first control unit 120 and the second control unit 160 is realized by, for example, a hardware processor such as a central processing unit (CPU) executing a program (software). Some or all of these components may be realized by hardware (circuit unit; including circuitry) such as a large scale integration (LSI), an application specific integrated circuit (ASIC), a field-programmable gate array (FPGA), a graphics processing unit (GPU), and may also be realized by cooperation of software and hardware. A program may be stored in a storage device such as an HDD of the automatic driving control device 100 or a flash memory in advance, and may also be installed in the HDD of the automatic driving control device 100 or the flash memory by being stored in a detachable storage medium such as a DVD or a CD-ROM, and mounting the storage medium on a drive device.

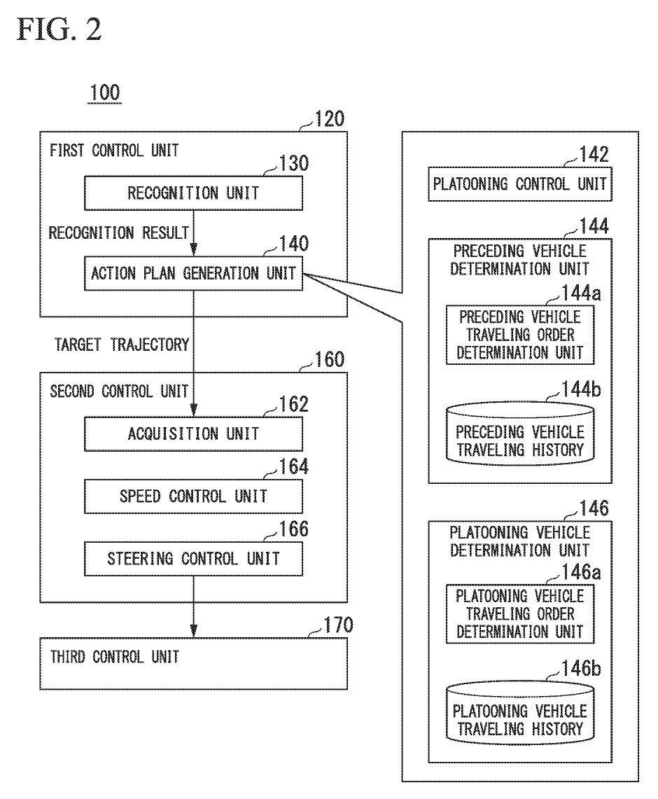

FIG. 2 is a functional configuration diagram of the first control unit 120 and the second control unit 160. The first control unit 120 includes, for example, a recognition unit 130 and an action plan generation unit 140. The first control unit 120 realizes, for example, a function of an artificial intelligence (AI) and a function of a previously given model in parallel. For example, a function of “recognizing an intersection” may be realized by executing recognition of an intersection by deep learning or the like and recognition based on previously given conditions (such as signals capable of allowing pattern matching, road signs, and the like) being executed in parallel, and scoring both sides to comprehensively evaluate them. This ensures reliability of automatic driving. The recognition unit 130 recognizes states such as a position, a speed, and an acceleration of an object in the vicinity of the vehicle M on the basis of information input from the camera 10, the radar device 12, and the finder 14 via the object recognition device 16. The position of an object is recognized as a position in absolute coordinates having a representative point of the vehicle M (a center of gravity, a driving axis center, and the like) as an origin, and is used for control, for example. The position of an object may be represented by a representative point such as a center of gravity or a corner of the object, and may also be represented by an expressed region. The “state” of an object may include the acceleration, jerk, or “behavior state” (for example, whether the object is changing or is trying to change a lane) of the object.

The recognition unit 130 recognizes, for example, a lane (a traveling lane) on which the vehicle M is traveling. For example, the recognition unit 130 recognizes a traveling lane by comparing a pattern of road lane markings obtained from the second map information 62 (for example, an array of solid lines and broken lines) and a pattern of a road lane marking around the vehicle M recognized from an image captured by the camera 10. The recognition unit 130 may also recognize a traveling lane by recognizing a track boundary (road boundary) which includes not only a road lane marking but also a road lane marking, a road shoulder, a curb stone, a median strip, a guard rail, and the like. In this recognition, a position of the vehicle M acquired from the navigation device 50 and a processing result by the INS may also be added. The recognition unit 130 recognizes pause lines, obstacles, red lights, toll gates, and other road events.

The recognition unit 130 recognizes the position and posture of the vehicle M with respect to a traveling lane when the traveling lane is recognized. The recognition unit 130 may recognize a deviation from a lane center of a reference point of the vehicle M and an angle formed with respect to a row connecting lane centers in a traveling direction of the vehicle M as a relative position and a posture of the vehicle M with respect to the traveling lane, for example. Alternatively, the recognition unit 130 may recognize a position and the like of the reference point of the vehicle M with respect to either side end of the traveling lane (road lane marking or road boundary) as a relative position of the vehicle M with respect to the traveling lane.

In principle, the action plan generation unit 140 travels on a recommended lane determined by the recommended lane determination unit 61, and furthermore the vehicle M automatically (independently of an operation of a driver) generates a target trajectory to travel on in the future such that the vehicle M can cope with situations therearound. The target trajectory includes, for example, a speed factor. For example, the target trajectory is expressed as a sequence of points to be reached by the vehicle M (trajectory point). A trajectory point is a point to be reached by the vehicle M for each predetermined travel distance (for example, about several [m]) as a road distance, and, apart from this, a target speed and target acceleration for each predetermined sampling time (for example, every several tenths of a [sec]) are generated as a part of the target trajectory. The trajectory point may be a position to be reached by the vehicle M at a corresponding sampling time for each predetermined sampling time. In this case, information on a target speed and target acceleration is expressed by an interval between trajectory points.

The action plan generation unit 140 may set an event of automatic driving in generation of a target trajectory. Events of automatic driving include a constant speed traveling event, a low speed follow-up traveling event, a lane change event, a branching event, a merging event, an overtaking event, and the like. The action plan generation unit 140 generates a target trajectory in accordance with an activated event. Functions of a platooning control unit 142, a preceding vehicle determination unit 144, and a platooning vehicle determination unit 146 of the action plan generation unit 140 will be described. The preceding vehicle determination unit 144 and the platooning vehicle determination unit 146 are examples of “determination unit.”

The second control unit 160 controls the traveling driving force output device 200, the brake device 210, and the steering device 220 such that the vehicle M passes along a target trajectory generated by the action plan generation unit 140 at a scheduled time.

Returning to FIG. 2, the second control unit 160 includes, for example, an acquisition unit 162, a speed control unit 164, and a steering control unit 166. The acquisition unit 162 acquires information on a target trajectory (trajectory points) generated by the action plan generation unit 140, and stores it in a memory (not shown). The speed control unit 164 controls the traveling driving force output device 200 or the brake device 210 on the basis of a speed factor associated with a target trajectory stored in the memory. The steering control unit 166 controls the steering device 220 in accordance with a bending degree of a target trajectory stored in the memory. Processing of the speed control unit 164 and the steering control unit 166 is realized by, for example, a combination of feedforward control and feedback control. As an example, the steering control unit 166 executes a combination of feedforward control in accordance with the curvature of a road ahead of the vehicle M and feedback control based on deviation from a target trajectory.

The traveling driving force output device 200 outputs a traveling driving force (torque) for traveling of a vehicle to driving wheels. The traveling driving force output device 200 includes, for example, a combination of an internal combustion engine, an electric motor, a transmission, and the like, and an ECU for controlling these. The ECU controls the above constituents according to information input from the second control unit 160 or information input from the driving operator 80.

The brake device 210 includes, for example, brake calipers, a cylinder that transmits a hydraulic pressure to the brake calipers, an electric motor that causes the cylinder to generate a hydraulic pressure, and a brake ECU. The brake ECU controls the electric motor according to the information input from the second control unit 160 or the information input from the driving operator 80 such that brake torque in accordance with a braking operation is output to each wheel. The brake device 210 may include a mechanism that transmits a hydraulic pressure generated by an operation of a brake pedal included in the driving operator 80 to a cylinder via a master cylinder as a backup. The brake device 210 is not limited to the configuration described above, and may also be an electronic control type hydraulic pressure brake device that controls an actuator according to the information input from the second control unit 160 and transmits a hydraulic pressure of a master cylinder to a cylinder.

The steering device 220 includes, for example, a steering ECU and an electric motor. The electric motor changes, for example, a direction of steered wheels by applying a force to a rack and pinion mechanism. The steering ECU drives the electric motor according to the information input from the second control unit 160 or the information input from the driving operator 80 to change the direction of steered wheels.

[Control at the Time of Performing Extended Platooning]

Hereinafter, a series of processing performed by the vehicle system 1 at the time of performing extended platooning will be described. The vehicle M on which the vehicle system 1 is mounted executes the following processing while performing inter-vehicle communication with other vehicles including the same system.

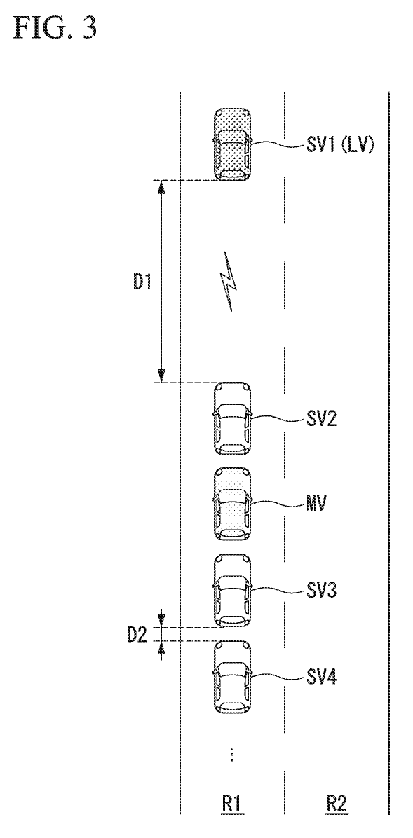

FIG. 3 is a diagram which shows an example of a positional relationship between extended platooning vehicles. In the first embodiment, extended platooning refers to a mode in which platooning vehicles travel by adding a preceding vehicle thereto. Platooning is, for example, a phenomenon in which a vehicle travels following to a vehicle traveling ahead at a predetermined inter-vehicle distance, and travels by adjusting a position of the vehicle body in a direction transverse to a traveling direction of the vehicle traveling ahead. A vehicle performing platooning can travel using only these feedback controls. In platooning, a vehicle may acquire a controlled variable of the brake device 210 or an output braking force from a vehicle traveling ahead of the vehicle, and control the brake device 210 on the basis of the acquired information.

A vehicle MV is a vehicle that controls platooning (hereinafter, a master vehicle). According to a result of mediation by inter-vehicle communication, an arbitrary vehicle is selected from all the platooning vehicles as a mater vehicle MV. As a master vehicle MV, for example, a vehicle which has the longest participating time and distance in platooning or a vehicle that calls for an implementation of platooning to vehicles traveling therearound is selected among vehicles equipped with the vehicle system 1. The other platooning vehicles (hereinafter, slave vehicles) travel in a traveling order determined by the master vehicle.

Vehicles SV1 to SV4 are slave vehicles traveling in the traveling order determined by the master vehicle MV. In the following description, if there is no particular distinction on which of the vehicles SV1 to SV4 of slave vehicles, it is called a “slave vehicle SV.”

A slave vehicle SV1 is a preceding vehicle LV. A preceding vehicle is a vehicle that travels ahead of platooning vehicles to recognize a traveling environment, and transmits a result of the recognition of a traveling environment to the master vehicle MV. A traveling environment recognized by the preceding vehicle LV is, for example, a result of determining whether the number of lanes increases or decreases, or whether an obstacle falls on a road, and, when an obstacle falls on a road, a result of determining whether it is possible to travel by passing through a top of the obstacle or whether it is better to avoid the obstacle by steering. The preceding vehicle LV notifies respective vehicles constituting a row that it is possible to travel by passing through the top of an obstacle when the obstacle is a wood or the like whose height is about 5 [cm] and whose horizontal width (a width occupying in a direction parallel to a traveling direction of a road) is 1 [m] or below, for example. Regardless of a size of an obstacle, even when it is determined that a tire of a vehicle contacts an obstacle or steps on an obstacle does not affect subsequent traveling, it is notified that it is possible to travel by passing through the top of an obstacle. The preceding vehicle LV notifies respective vehicles constituting a row to avoid an obstacle by steering, for example, when a height of the obstacle is about 10 [cm], when a horizontal width is 1 [m] or above, or when it is determined whether it is not possible to pass through the top of the obstacle. Content of recognition on the traveling environment includes not only an obstacle on a road but also other vehicles stopping on a road shoulder, for example.

The preceding vehicle LV, for example, may be positioned about a few meters ahead of the beginning of platooning vehicles, may be positioned about several tens to hundreds meters ahead, and may also be positioned about several kilometers ahead. How far ahead the preceding vehicle LV travels may be adjusted by the master vehicle MV in accordance with the number of platooning vehicles and the number of vehicles other than the platooning vehicles traveling in the vicinity, for example.

In the following description, an inter-vehicle distance between the preceding vehicle LV and a slave vehicle SV2 which is a leading vehicle of platooning vehicles is referred to as a first distance D1, and an inter-vehicle distance between vehicles traveling in a relationship immediately before and immediately after among the platooning vehicles (for example, a slave vehicle SV2 and a slave vehicle SV3) is referred to as a second distance D2. The master vehicle MV adjusts speeds of the preceding vehicle LV and the platooning vehicles such that the first distance D1 is sufficiently larger than the second distance D2. The master vehicle MV adjusts the first distance D1 and the second distance D2 such that a vehicle positioned at a head of the platooning vehicles can appropriately respond with a sufficient margin, for example, even when the preceding vehicle LV suddenly stops or lane changes. The slave vehicle SV may acquire a control amount of the brake device 210 or an output braking force from the preceding vehicle LV, and control the brake device 210 on the basis of the acquired information.

As shown in FIG. 3, the master vehicle MV is, for example, positioned in the middle of the platooning vehicles. The master vehicle MV may be positioned at the head of the platooning vehicles or at a rear thereof as long as it can communicate with the preceding vehicle LV. The slave vehicle SV2 which is the leading vehicle of the platooning vehicles shown in FIG. 3 is liable to be influenced by air resistance than other platooning vehicles, and there is a possibility of consuming a lot of driving energy. For this reason, the slave vehicle SV2 may exchange a traveling order with another slave vehicle SV3, a slave vehicle SV4, and the master vehicle MV at an arbitrary timing. Although FIG. 3 shows an example in which there is only one preceding vehicle, but the preceding vehicle may be composed of a plurality of preceding vehicles.

Hereinafter, a method of selecting a preceding vehicle LV using a master vehicle MV will be described. The master vehicle MV selects a slave vehicle SV1 with higher external recognition performance than the slave vehicles SV2 to SV4 as a preceding vehicle LV. The external recognition performance refers to, for example, a performance of an object recognition device (for example, a camera, a radar device, or a vehicle sensor) provided in the slave vehicle SV1.

The master vehicle MV determines that external recognition performance of the slave vehicle SV1 is high when a recognition range of an object recognition device included in the vehicle LV is larger than a reference range set in advance in the master vehicle MV, for example. The master vehicle MV may perform relative comparison on external recognition performances of the slave vehicles SV1 to SV4 to determine a height of a corresponding external recognition performance. If all vehicles have equivalent recognition performances, a vehicle with a larger vertical distance from a horizontal ground surface to the lowest place of a vehicle body (for example, a ground surface side of a side sill) may be higher in external recognition performance. It is because a vehicle with a larger vertical distance from a horizontal ground surface to the lowest place of a vehicle body is more likely to be able to avoid an obstacle by passing through the top so as not to step on the obstacle, and can more flexibly select whether to avoid an obstacle by steering or to pass through the top of an obstacle. For example, when a sport utility vehicle (SUV) and a sedan vehicle which have an equivalent external recognition performance are compared with each other, the master vehicle MV determines that the SUV vehicle has a higher external recognition performance.

The master vehicle MV receives information on an external recognition performance of each vehicle from, for example, the slave vehicles SV1 to SV4, and determines the slave vehicle SV1 having higher external recognition performance as the preceding vehicle LV on the basis of a result of the reception.

The preceding vehicle LV, according to its characteristics, can perform a sudden lane change when an obstacle and the like on a road are encountered, or can perform a steering which is unpleasant to an occupant such as a sudden change in acceleration or deceleration and the like. Therefore, when a vehicle with the highest external recognition performance among surrounding vehicles is a manned vehicle, the vehicle is not selected as the preceding vehicle LV, and then the platooning control unit 142 selects a vehicle with the second higher external recognition performance as the preceding vehicle LV.

[Function of Platooning Control Unit]

Hereinafter, returning to FIG. 2, processing in which the master MV controls a start of platooning will be described. Hereinafter, it is described that the vehicle M is selected as the master vehicle MV and operates, in principle.

The platooning control unit 142 calls vehicles traveling in the vicinity to start or end platooning on the basis of a result of recognition indicating that preparation for starting platooning is ready, which is output by the recognition unit 130, or performs traveling control of each vehicle during platooning. A fact that the preparation for starting platooning is ready is determined on the basis of a result of recognition by the recognition unit 130 indicating that a certain period of time has elapsed from a start of traveling on an expressway or a result of recognition by the recognition unit 130 for an existence of a peripheral vehicle scheduled to travel a route similar to that of a host vehicle, for example.

The platooning control unit 142 calls other vehicles in the vicinity for platooning using the communication device 20. The platooning control unit 142 receives information on a route and information identifying a vehicle from other vehicles that have agreed to the call for platooning among the other vehicles that call for platooning.

The platooning control unit 142 selects at least one candidate for a preceding vehicle which satisfies a first condition from the information identifying other vehicles that have agreed to the call for platooning. The first condition is a condition for determining whether the other vehicles are suitable for a preceding vehicle. The first condition is, for example, that the external recognition performance is high and that a vehicle is an unmanned automatic driving vehicle. The platooning control unit 142 outputs a result of selecting a candidate for a preceding vehicle to the preceding vehicle determination unit 144. The platooning control unit 142 outputs information identifying the other vehicles that have agreed to the call for platooning to the platooning vehicle determination unit 146.

[Function of Preceding Vehicle Determination Unit]

The preceding vehicle determination unit 144 includes, for example, a preceding vehicle traveling order determination unit 144a, and a preceding vehicle traveling history 144b.

The preceding vehicle traveling order determination unit 144a selects at least one preceding vehicle LV from candidates for a preceding vehicle. The preceding vehicle traveling order determination unit 144a determines a traveling order when there are selectively a plurality of vehicles which are candidates for a preceding vehicle. The preceding vehicle traveling order determination unit 144a may determine an alternating order when a plurality of vehicles alternately become a preceding vehicle.

When there are a plurality of vehicles (for example, about five vehicles) which are candidates for a preceding vehicle, and only some of the vehicles (for example, about 1 or 2 vehicles) among the candidates are set as a preceding vehicle LV, the preceding vehicle traveling order determination unit 144a determines a vehicle traveling as a first preceding vehicle LV. When there are a plurality of vehicles which are the candidates for a preceding vehicle, the preceding vehicle traveling order determination unit 144a may select a vehicle positioned foremost in a traveling direction as a vehicle traveling as the first preceding vehicle LV, and a vehicle with the most energy surplus among the vehicles may be selected as a vehicle traveling as a first preceding vehicle LV at a time of determining a traveling order. When there are a plurality of vehicles which are the candidates for a preceding vehicle, and a vehicle traveling as a first preceding vehicle LV has been already determined, the preceding vehicle traveling order determination unit 144a may determine a vehicle traveling as a next preceding vehicle LV in advance.

The preceding vehicle traveling order determination unit 144a outputs a result of selecting a preceding vehicle LV to the preceding vehicle traveling history 144b. The preceding vehicle traveling order determination unit 144a refers to the preceding vehicle traveling history 144b when there are a plurality of candidates for a preceding vehicle, and determines a vehicle traveling as the preceding vehicle LV at an arbitrary timing. The preceding vehicle traveling order determination unit 144a outputs information identifying a vehicle to the platooning vehicle traveling order determination unit 146a, for example, when the candidates for a preceding vehicle are caused to travel as platooning vehicles.

When the other vehicles that have agreed to the call for platooning have equivalent performance and the candidates for a preceding vehicle cannot be selected, the preceding vehicle traveling order determination unit 144a determines an arbitrary number of vehicles positioned ahead in a traveling direction among the other vehicles as preceding vehicles LV.

[Function of Platooning Vehicle Determination Unit]

The platooning vehicle determination unit 146 includes, for example, a platooning vehicle traveling order determination unit 146a and a platooning vehicle traveling history 146b.

The platooning vehicle determination unit 146 determines a vehicle that performs platooning. When the number of other vehicles that agree to the call for platooning exceeds the number of vehicles suitable for platooning, the platooning vehicle determination unit 146 sets only an arbitrary number of peripheral vehicles among the other vehicles that agree to the call for platooning as objects of platooning, thereby performing adjustment such that a row does not become too long. When an arbitrary number of peripheral vehicles among the other vehicles that agree to the call for platooning are selected as platooning vehicles, the platooning vehicle determination unit 146 may also use a presence or absence of an occupant in the other vehicles as selection criteria. An arbitrary number may be derived from a result of recognizing a peripheral situation by the vehicle system 1, an upper limit number may also be set as an initial value of the vehicle system 1, and the arbitrary number may also be derived from the number of preceding vehicles LV or the external recognition performance of the preceding vehicle LV.

The platooning vehicle traveling order determination unit 146a determines a traveling order of platooning vehicles. The platooning vehicle traveling order determination unit 146a first determines a slave vehicle SV first traveling at the head among the platooning vehicles. The platooning vehicle traveling order determination unit 146a may select a slave vehicle SV positioned at the forefront in a traveling direction as a slave vehicle SV traveling at the head, and may select a slave vehicle SV having the largest energy surplus among the platooning vehicles as the slave vehicle SV traveling at the head. The platooning vehicle traveling order determination unit 146a determines a traveling order by considering that the slave vehicles SV output from the preceding vehicle traveling order determination unit 144a and which are candidates for a leading vehicle travel at the head of a row. The platooning vehicle traveling order determination unit 146a outputs a result of selecting the slave vehicles SV traveling at the head and an order of platooning vehicles to the platooning vehicle traveling history 146b. The platooning vehicle determination unit 146 determines that an alternating timing of a slave vehicle SV traveling at the head is reached when predetermined conditions are satisfied. The predetermined conditions are, for example, that a predetermined period of time or more has elapsed since a slave vehicle SV traveling at the head starts traveling at the head and that the vehicle has traveled a predetermined distance or more. The platooning vehicle traveling order determination unit 146a refers to, for example, the platooning vehicle traveling history 146b, and determines a slave vehicle SV traveling at the head next. The platooning vehicle traveling order determination unit 146a may determine a slave vehicle SV traveling at the head next in advance, or may determine a slave vehicle SV traveling at the head next when the platooning vehicle determination unit 146 determines that a timing to alternate a slave vehicle SV currently traveling at the head is reached.

[Control after Platooning Start]

The platooning control unit 142 outputs an instruction such that a preceding vehicle LV is positioned in an order determined by the preceding vehicle traveling order determination unit 144a and slave vehicles SV in an initial platooning order determined by the platooning vehicle traveling order determination unit 146a. The platooning control unit 142 confirms that the slave vehicles SV are positioned in an instructed platooning order, and starts control of platooning.

When the vehicle M is a slave vehicle SV, the platooning control unit 142 controls the acceleration and deceleration and steering of the vehicle M such that the vehicle M is positioned in the initial platooning order according to an instruction output from the master vehicle MV.

The platooning control unit 142 determines whether to cancel platooning at an arbitrary timing during the platooning. The platooning control unit 142 determines to cancel platooning, for example, when it is better to entrust driving control to individual vehicles such as when a vehicle approaches a junction or when there are a large number of manned driving vehicles occupying a road during traveling.

When the vehicle M is a manned vehicle, the platooning control unit 142 may operate a traffic jam pilot (hereinafter, referred to as TJP) system or an equivalent system while platooning is continued. TJP is, for example, a control mode in which a vehicle follows a preceding vehicle at a predetermined speed (for example, 60 [km/h]) or below or a control mode in which a vehicle follows a preceding vehicle while traveling on an expressway. The TJP may be activated, for example, when the speed of the vehicle M is equal to or less than the predetermined speed, and an inter-vehicle distance from a preceding vehicle is within a predetermined distance. The HMI 30 notifies an occupant whether the TJP is being executed or whether it is in a state in which transition to a driving support of the TJP is possible. The platooning control unit 142 performs communication that an automatic driving level of a manned vehicle with a driver therein which constitutes a row may be set to level 3 (a state in which the driver does not have to constantly monitor a traveling state) or a level higher than level 3 via the communication device 20. Whether each vehicle sets TJP may also be selected by a driver of each vehicle. The platooning control unit 142 may also cause the TJP system or an equivalent system to operate while platooning is continued even when the vehicle M is a slave vehicle SV.

The platooning control unit 142 allows the deceleration of the vehicle M to an extent that it does not affect loads and the like loaded by platooning vehicles (for example, a deceleration of about 0.8 [G] at maximum) when the vehicle M is an unmanned vehicle. When the vehicle M is a manned vehicle, the platooning control unit 142 makes the deceleration of the vehicle M stricter than a deceleration limit of an unmanned vehicle (for example, it is within a deceleration of about 0.3 [G] which is assumed that an occupant does not feel uncomfortable). The platooning control unit 142 adjusts the deceleration in the same manner even when the vehicle M is a slave vehicle SV.

When the vehicle m is an unmanned vehicle and a preceding vehicle is an unmanned vehicle, the platooning control unit 142 may set an inter-vehicle distance between the unmanned vehicles (a second distance D2) smaller than a distance set when any of the vehicles is a manned vehicle such that slipstream which can occur behind the preceding vehicle can be used. The platooning control unit 142 may also perform control to reduce the inter-vehicle distance in the same manner even when the vehicle M is a slave vehicle SV.

[Processing Flow 1: Start of Extended Platooning]

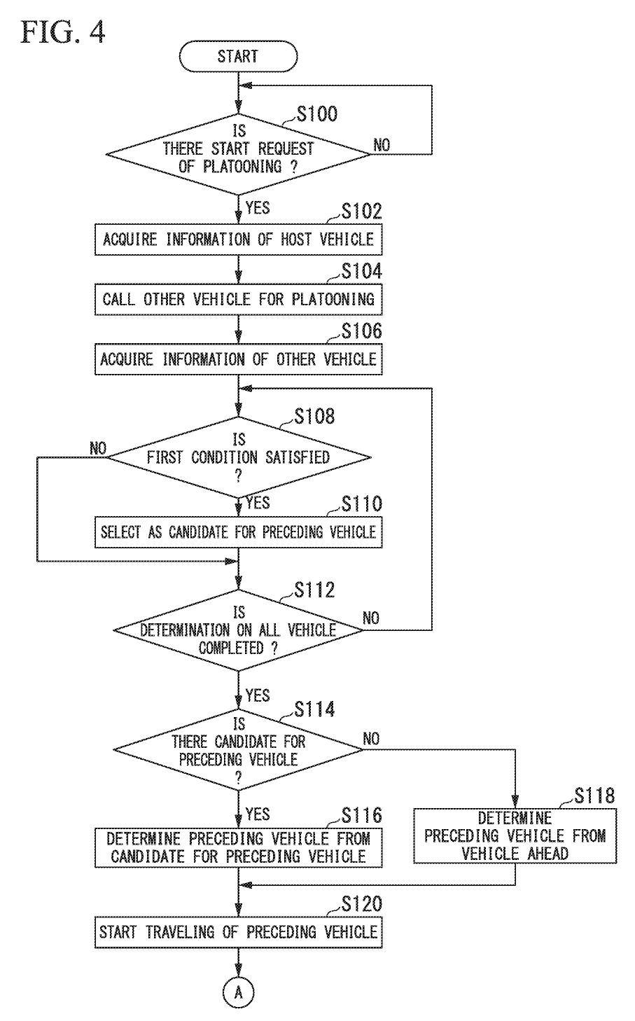

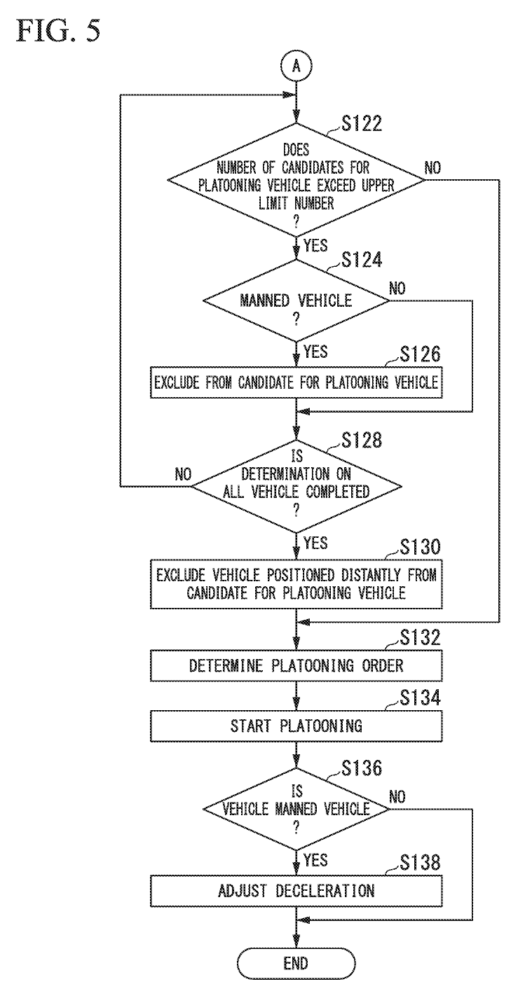

Next, an example of processing of controlling extended platooning vehicles using the master vehicle MV will be described with reference to FIGS. 4 and 5. FIG. 4 is a flowchart which shows an example of processing of determining a preceding vehicle and causing it to travel using the platooning control unit 142 and the preceding vehicle determination unit 144.

The platooning control unit 142 determines whether preparation for starting platooning is ready (step S100). The platooning control unit 142 acquires information on a route of the vehicle M when it is determined that the preparation for starting platooning is ready (step S102). The platooning control unit 142 performs step S100 again after a certain period of time when it is determined that the preparation for starting platooning is not ready.

Next, the platooning control unit 142 calls other vehicle for platooning (step S104). Next, the platooning control unit 142 acquires information on a route of other vehicles that have agreed to the call for platooning and information identifying a vehicle (step S106). Then, the platooning control unit 142 determines whether a vehicle that agrees to the call for platooning satisfies the first condition (step S108). When it is determined that a vehicle satisfies the first condition, the platooning control unit 142 selects the vehicle as a candidate for a preceding vehicle (step S110). Next, when it is determined that a vehicle does not satisfy the first condition, step S112 is performed.

Next, the platooning control unit 142 determines whether determination on all vehicles has been completed (step S112). When it is determined that determination on all vehicles has not been completed, the platooning control unit 142 performs processing from step S108 again. When it is determined that determination on all vehicle has been completed, the preceding vehicle determination unit 144 determines whether there are one or more selected candidates for a preceding vehicle (step S114). When it is determined that there are one or more selected candidates for a preceding vehicle, the preceding vehicle determination unit 144 determines a preceding vehicle LV from the candidates for a preceding vehicle (step S116). When it is determined that there are not one or more selected candidates for a preceding vehicle, the preceding vehicle determination unit 144 determines a preceding vehicle LV from vehicles traveling ahead in a traveling direction among vehicles that have agreed to the call for platooning (step S118). Next, the preceding vehicle determination unit 144 causes a determined vehicle to start traveling as the preceding vehicle LV (step S120). As described above, description of the processing in the present flowchart is ended.

FIG. 5 is a flowchart which shows an example of processing of determining platooning vehicles and causing them to travel using the platooning control unit 142 and the platooning vehicle determination unit 146. Steps S112 to S134 are processing of the master vehicle MV, and steps S136 to S138 are processing performed not only on the master vehicle MV but also on the slave vehicle SV.

The platooning vehicle determination unit 146 determines whether the number of candidates for platooning vehicles that have agreed to the call for platooning exceeds an upper limit number set by the vehicle system 1 (step S122). When it is determined that it does not exceed the upper limit number, the processing of step S132 is performed. When it is determined that it exceeds the upper limit number, the platooning vehicle determination unit 146 determines whether a vehicle is a manned vehicle (step S124). When it is determined that a vehicle is a manned vehicle, the platooning vehicle determination unit 146 excludes a corresponding vehicle from the candidates for platooning vehicles (step S126). Next, the platooning vehicle determination unit 146 determines whether determination on all vehicles has been completed (step S128). When it is determined that determination on all vehicles has been completed, the platooning vehicle determination unit 146 excludes vehicles positioned distantly among the number of candidates for platooning vehicles exceeding the upper limit number from the candidates for platooning vehicles (step S130). When it is determined that determination on all vehicles has not been completed, the procedure returns to the processing of step S122. Next, the platooning vehicle determination unit 146 determines a traveling order of platooning vehicles (step S132), and starts platooning (step S134).

Next, the platooning control unit 142 of each vehicle determines whether respective vehicles constituting a row are manned vehicles (step S136). When it is determined that it is not a manned vehicle, the procedure ends processing. When it is determined that it is a manned vehicle, the platooning control unit 142 adjusts the deceleration of a corresponding vehicle (step S138). As a result, processing of the present flowchart ends.

[Traveling Order Change of Preceding Vehicle]

In the following description, processing of the platooning control unit 142 and the preceding vehicle determination unit 144 performed when a preceding vehicle is replaced will be described.

When a current preceding vehicle LV (hereinafter, referred to as a “first preceding vehicle”) satisfies a second condition after it starts to travel as a preceding vehicle, the preceding vehicle determination unit 144 replaces the preceding vehicle with another slave vehicle SV. The second condition is, for example, a condition when a certain period of time has elapsed since the first preceding vehicle starts to travel as a preceding vehicle, a condition when the vehicle has traveled a certain distance, or a condition when a remaining amount of driving energy of the first preceding vehicle becomes a certain amount or less. Hereinafter, a vehicle which becomes a next preceding vehicle by the replacement is referred to as a “second preceding vehicle.” When the second preceding vehicle is selected in advance, the preceding vehicle determination unit 144 determines that the vehicle is a next preceding vehicle, and, when the second traveling vehicle is not determined, selects and determines a second traveling vehicle among platooning vehicles.

The preceding vehicle determination unit 144 determines the second preceding vehicle in the same determination method as when the first preceding vehicle is determined. That is, when there is an unmanned vehicle with high external recognition performance as a candidate for the second preceding vehicle, the preceding vehicle determination unit 144 determines the slave vehicle SV as the second preceding vehicle. When there is no unmanned vehicle with high external recognition performance as the candidate for the second preceding vehicle, the preceding vehicle determination unit 144 determines an unmanned vehicle positioned ahead among the platooning vehicles as the second preceding vehicle. The preceding vehicle determination unit 144 outputs information identifying the second preceding vehicle to the platooning control unit 142.

After the second preceding vehicle is determined by the preceding vehicle determination unit 144, the platooning control unit 142 transmits a traveling instruction such that the preceding vehicle LV is replaced by causing the second preceding vehicle to overtake the first preceding vehicle via the communication device 20 and the second preceding vehicle starts to travel as a preceding vehicle.

[Processing Flow 2: Replacement of Preceding Vehicle]

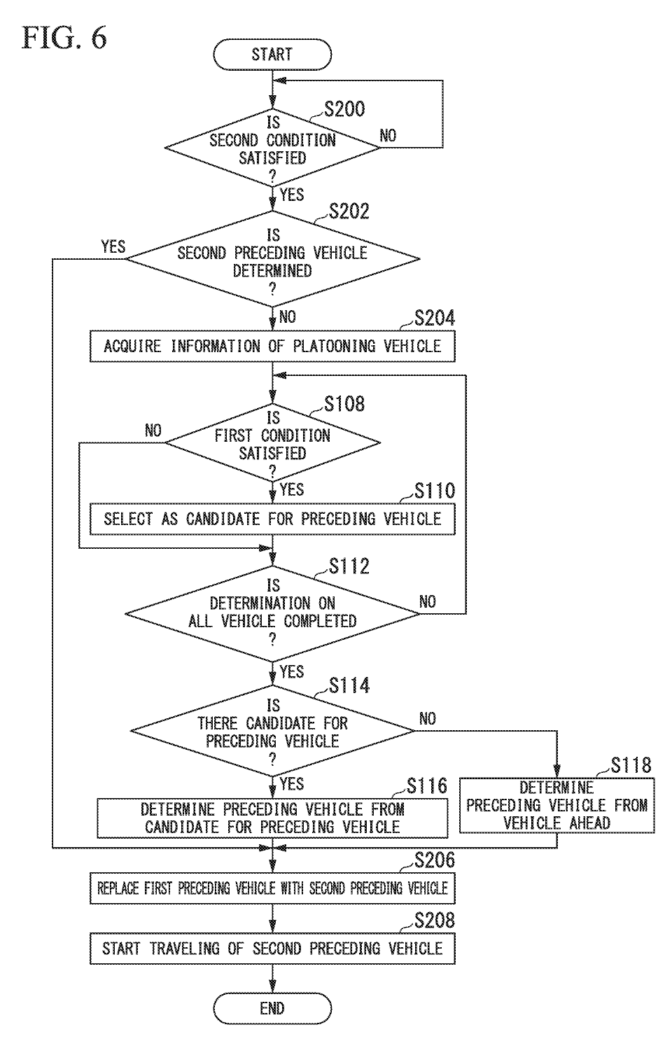

Next, an example of processing in which the master vehicle MV alternates the preceding vehicle LV will be described with reference to FIG. 6. FIG. 6 is a flowchart which shows an example of processing of replacing the preceding vehicle LV using the platooning control unit 142 and the preceding vehicle determination unit 144. Since a flow of processing of determining the second preceding vehicle has the same processing as step S108 to step S118 of the flowchart shown in FIG. 4, processing from step S200 to step S208 will be mainly described in the following description.

The preceding vehicle determination unit 144 determines whether the first preceding vehicle satisfies the second condition (step S200). When it is determined that it does not satisfy the second condition, the preceding vehicle determination unit 144 performs the processing of step S200 again after a certain period of time elapses. When it is determined that it satisfies the second condition, the preceding vehicle determination unit 144 determines whether the second preceding vehicle has been already determined (step S202). When it is determined that the second preceding vehicle has not been already determined, the preceding vehicle determination unit 144 acquires information of platooning vehicles (step S204), and performs processing of step S206 after the processing of step S108 to step S118 is performed. When it is determined that the second preceding vehicle has been already determined, the platooning control unit 142 performs the processing of step S206.

The platooning control unit 142 replaces the first preceding vehicle with a second preceding vehicle determined by the preceding vehicle determination unit 144 (step 206), and causes a traveling of the second preceding vehicle as the preceding vehicle LV to start (step S208). This ends processing of the present flowchart.

According to the vehicle system 1 of the first embodiment described above, it is possible to realize more preferred extended platooning based on information on a traveling environment and the like recognized by the preceding vehicle LV by using the platooning control unit 142 that calls vehicles traveling in the vicinity for constituting a row, selects a preferred preceding vehicle LV and slave vehicles SV among vehicles that have agreed to the call, and controls traveling of the selected slave vehicles SV, the preceding vehicle determination unit 144 that determines a preceding vehicle LV which travels ahead of a row and provides information on a traveling environment to the row, and the platooning vehicle determination unit 146 that controls a traveling order of platooning vehicles constituted by slave vehicles SV other than the master vehicle MV and the preceding vehicle LV.

As described above, according to the first embodiment, it is possible to disperse a burden of traveling as the preceding vehicle LV and to causing platooning to continue for a longer time by performing processing of replacing the preceding vehicle LV at an arbitrary timing using the preceding vehicle determination unit 144.

In the present embodiment, the vehicle M is described to be an automatic driving vehicle as a premise, but may also be a manual driving vehicle. In this case, the driver of the vehicle M may perform a driving operation by displaying an instruction to the HMI 30 to display a vehicle behavior for maintaining a predetermined position as platooning or the preceding vehicle LV, and the like.

### Second Embodiment

Next, the vehicle system 1 of a second embodiment will be described. In the following description, a part having the same function as content described in the first embodiment will be denoted by the same name and reference numeral, and a detailed description for this function will be omitted.

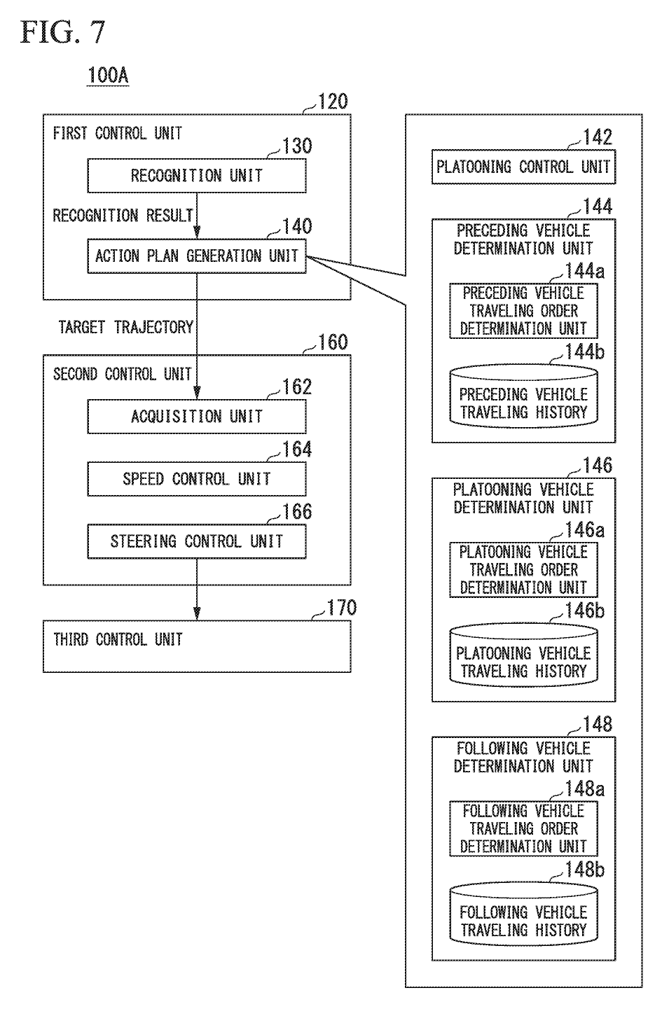

FIG. 7 is a functional configuration diagram of a first control unit 120 and a second control unit 160 of the automatic driving control device 100A in the second embodiment. The automatic driving control device 100A of FIG. 7 is different from the automatic driving control device 100 of the first embodiment in that it includes a following vehicle determination unit 148. Therefore, the following vehicle determination unit 148 will be mainly described in the following description. The following vehicle determination unit 148 is another example of the “determination unit.”

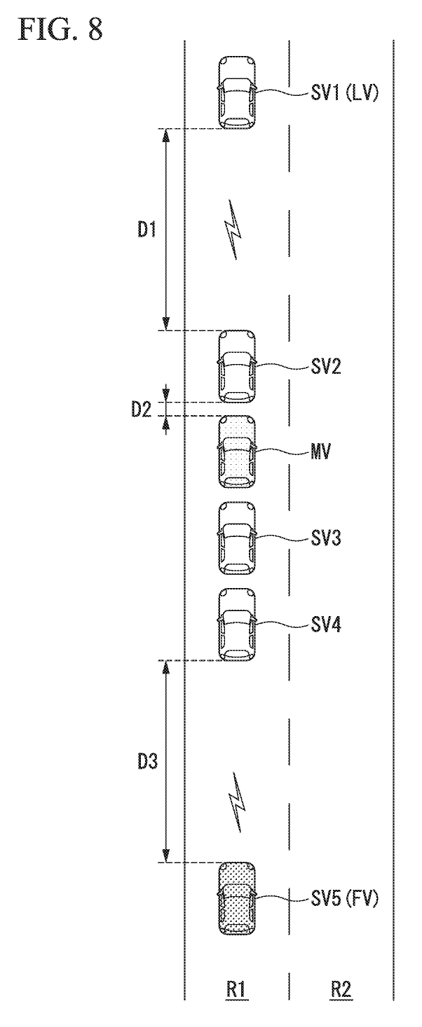

FIG. 8 is a schematic diagram which shows another example of a positional relationship between extended platooning vehicles. In the second embodiment, extended platooning refers to a mode in which a preceding vehicle and a following vehicle are added to platooning vehicles and travel. In the example shown in FIG. 8, there is a row constituted by the slave vehicle SV1 (LV) that is a preceding vehicle, the master vehicle MV, the slave vehicles SV2 to SV4, and the slave vehicle SV5 (FV) that is a following vehicle. A following vehicle is a vehicle following a last vehicle of the platooning vehicles by a distance larger than the inter-vehicle distance D2 between the platooning vehicles. A following vehicle is, for example, a vehicle that recognizes a vehicle approaching the rear side of a row or recognizes a congestion situation of the rear side of a row, and transmits a result of the recognition to the master vehicle MV. A following vehicle is positioned, for example, about tens to hundreds of [m] behind other vehicles.

Hereinafter, an inter-vehicle distance between the slave vehicle SV4 which travels at a tail end of the platooning vehicles and the following vehicle FV which travels in this direction is referred to as a third distance D3. The master vehicle MV adjusts an acceleration and a deceleration of the following vehicle FV such that the third distance D3 is sufficiently larger than the second distance D2. The master vehicle MV adjusts the third distance D3 such that the platooning vehicles can appropriately respond with a sufficient margin, for example, when other vehicles approach from the rear of the following vehicle FV at a high speed or when the following vehicle FV overtakes or is overtaken from other vehicles other than the platooning vehicles. Although FIG. 8 shows an example in which there is only one following vehicle, but there may be a plurality of following vehicles.

[Selection of Following Vehicle]

Hereinafter, processing of selecting candidates for a following vehicle using the platooning control unit 142 will be described. The platooning control unit 142 selects at least one candidate for a following vehicle satisfying a third condition from information identifying other vehicles that have agreed to the call for platooning. The third condition is a condition for determining whether other vehicles are suitable for a following vehicle. The third condition is, similar to the first condition, for example, that a vehicle has a high external recognition performance and that a vehicle is an automatic unmanned driving vehicle. The third condition may include, for example, that a vehicle has a high ability to avoid contact with other vehicles and that a vehicle has a high ability to reduce damage at the time of contacting with other vehicles.

When other vehicles that have agreed to the call for platooning have equivalent performance and the candidates for a following vehicle cannot be selected, the platooning control unit 142 selects an arbitrary number of vehicles positioned in the rear in a traveling direction as a following vehicle FV among the other vehicles. The platooning control unit 142 outputs a result of selecting the candidates for a following vehicle to the following vehicle determination unit 148.

The platooning control unit 142 performs adjustment such that candidates for a preceding vehicle and candidates for a following vehicle do not overlap. The platooning control unit 142 excludes, for example, vehicles selected as the candidates for a preceding vehicle from objects to be determined as the candidates for a following vehicle. The platooning control unit 142 may also determine each time in which of the preceding vehicle LV and the following vehicle FV to dispose a vehicle with higher external recognition performance on the basis of a traveling environment. The platooning control unit 142 may set that a vehicle with higher external recognition performance is disposed in the preceding vehicle LV as an initial setting of the vehicle system 1 in advance, for example.

[For Function of Following Vehicle Determination Unit]

The following vehicle determination unit 148 includes, for example, a following vehicle traveling order determination unit 148a and a following vehicle traveling history 148b.

The following vehicle traveling order determination unit 148a selects at least one or more following vehicles FV from candidates for a following vehicle. When there are a plurality of vehicles selected as the candidates for a following vehicle, the following vehicle traveling order determination unit 148a determines a traveling order of them. The following vehicle traveling order determination unit 148a may determine an order of a case in which a plurality of vehicles sequentially become a following vehicle.

When there are a plurality of vehicles which are the candidates for a following vehicle, the following vehicle traveling order determination unit 148a first determines a vehicle initially traveling as a following vehicle FV. The following vehicle traveling order determination unit 148a may select a vehicle positioned in the most rear in the traveling direction as a vehicle initially traveling as the following vehicle FV at the time of performing processing of determining a traveling order, and may use other selection criteria.

When there are a plurality of vehicles regarded as the candidates for a following vehicle, and when a slave vehicle SV initially traveling as the following vehicle FV has been already determined, a next slave vehicle SV traveling as the following vehicle FV may be determined in advance in the following vehicle traveling order determination unit 148a. The following vehicle traveling order determination unit 148a outputs a result of selecting the following vehicle FV to the following vehicle traveling history 148b. Among the candidates for a following vehicle, a salve vehicle SV which is not selected as the following vehicle FV may travel as a platooning vehicle until it replaces the following vehicle FV.

When a current following vehicle (hereinafter, referred to as a “first following vehicle”) satisfies a fourth condition after starting to travel as a following vehicle, the following vehicle determination unit 148 replaces the following vehicle FV with another slave vehicle SVd. The fourth condition is, for example, a case in which a certain period of time has elapsed, a case in which a vehicle has traveled a certain distance, or a case in which a remaining amount of driving energy of the first following vehicle FV becomes equal to or less than a certain amount. Hereinafter, a slave vehicle SV which becomes a next following vehicle FV by replacement is referred to as a “second following vehicle.” The following vehicle determination unit 148, when a second following vehicle is selected in advance, determines the vehicle, and, when a second following vehicle is not determined, determines a second traveling vehicle among the platooning vehicles. The fourth condition may be the same as the second condition used as a determination criteria for replacing the preceding vehicle LV, and a condition different from the second condition may also be set.

[Avoidance by Steering]

In the following description, processing in which the platooning control unit 142 causes platooning vehicles to perform avoidance by steering will be described.

The platooning control unit 142 determines whether to continue traveling on the same lane or whether it is necessary to avoid by steering on the basis of route information output from the navigation device 50 at any time. Avoidance by steering is to change, for example, a lane on which a row travels. When a notification that it is better to avoid an obstacle by steering is received from the preceding vehicle LV, or when a notification that it is better to change a lane is received from the following vehicle FV, the platooning control unit 142 determines that avoidance is required. When no notification indicating that it is better to cancel platooning is particularly obtained from the notification from the preceding vehicle LV and the like, the platooning control unit 142 determines that traveling on the same lane may be continued.

When it is determined that avoidance by steering is necessary, the platooning control unit 142 transmits a traveling instruction to control acceleration and deceleration so as to widen the second distance D2 to platooning vehicles via the communication device 20. When the platooning vehicles are manned vehicles, the platooning control unit 142 makes a limit to the deceleration of the vehicle M more strictly than a limit to the deceleration in the case of unmanned vehicles (that is, deceleration is made more gently)

The platooning control unit 142 transmits an instruction to generate a steering target trajectory for platooning vehicles performing avoidance by steering to the platooning vehicles via the communication device 20. The platooning control unit 142 causes avoidance by steering to start initially from a following vehicle. By performing such control, it is possible to secure space for all the vehicles constituting a row to perform avoidance by steering.

The platooning control unit 142 causes respective vehicles constituting a row to perform avoidance by steering upon receiving a notification that avoidance by steering of a following vehicle is completed. The platooning control unit 142 may perform avoidance by steering in an order from a vehicle positioned at the rear of a row, and may also allow a plurality of vehicles to perform avoidance by steering at the same time. The platooning control unit 142 ends the processing regarding avoidance by steering once receiving a notification of avoidance completion from all the vehicles constituting a row.

When the vehicle M is the slave vehicle SV, the platooning control unit 142 generates a steering target trajectory if an instruction to generate a steering target trajectory for performing avoidance by steering is received from the master vehicle MV. When the vehicle M is a manned vehicle, the platooning control unit 142 makes the deceleration of the vehicle M stricter than a deceleration limit of an unmanned vehicle. The platooning control unit 142 performs avoidance by steering on the basis of the steering target trajectory when a traveling instruction to perform avoidance is received from the master vehicle MV. Upon completion of avoidance by steering, the vehicle M notifies the master vehicle MV of the completion.

When there are other vehicles traveling in the vicinity of or at the rear of a row, the master vehicle MV or the following vehicle FV may also notify the vehicles that avoidance by steering is planned, and of a start and an end of the avoidance by steering.

[Processing Flow 3. Start of Platooning]

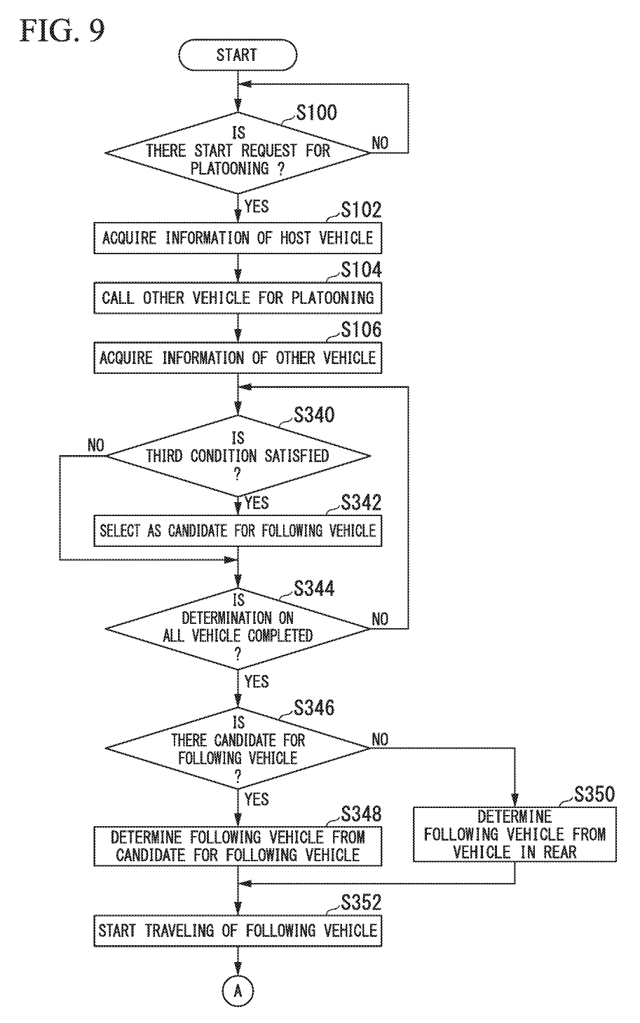

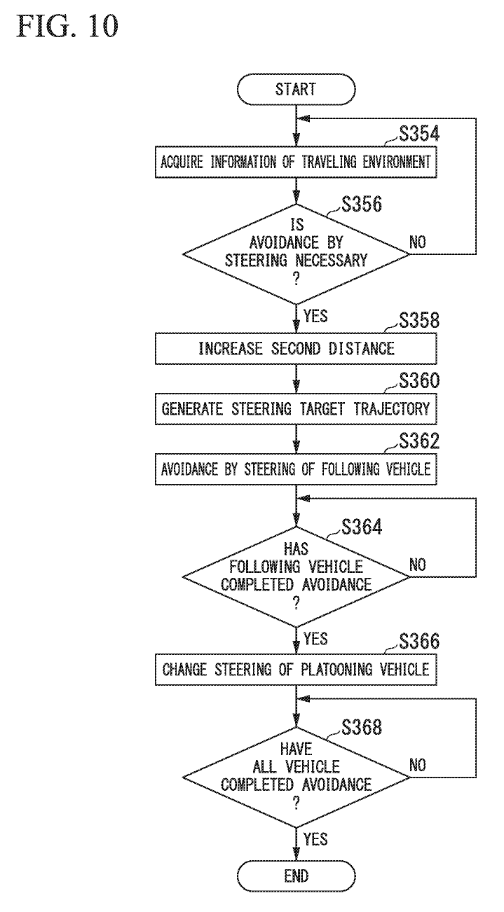

Next, another part of the flow of the processing of starting extended platooning will be described with reference to FIGS. 9 and 10. FIG. 9 is a flowchart which shows an example of the flow of processing of selecting the following vehicle FV and causing it to travel when extended platooning is started by the master vehicle MV. Steps S100 to S106 of FIG. 9 are the same steps as in the flowchart shown in FIG. 4. Therefore, processing from step S340 will be described in the following description. The processing from step S340 of FIG. 9 may be performed in parallel with the processing from step S108 of the flowchart shown in FIG. 4, and the processing from step S340 shown in the flowchart of FIG. 9 may also be performed after the processing shown in the flowchart shown in FIG. 4 is completed.

After the processing of step S106, the platooning control unit 142 determines whether a vehicle that has agreed to the call for platooning satisfies the third condition (step S340). When it is determined that the vehicle satisfies the third condition, the platooning control unit 142 selects the vehicle as a candidate for a following vehicle (step S342). When it is determined that the vehicle does not satisfy the third condition, the procedure proceeds to step S344.

Next, the platooning control unit 142 determines whether determination on all the vehicles is completed (step S344). When it is determined that determination on all the vehicles has not been completed, the platooning control unit 142 performs the processing from step S340 again. When it is determined that determination on all the vehicles has been completed, the preceding vehicle determination unit 144 determines whether there are one or more selected candidates for a following vehicle (step S346). When it is determined that there are one or more selected candidates for a following vehicle, the following vehicle determination unit 148 determines a following vehicle FV from the candidates for a following vehicle (step S348). When it is determined that there is are not one or more selected candidates for a following vehicle, the following vehicle determination unit 148 determines a following vehicle FV from vehicles traveling at the rear in the traveling direction among the vehicles that have agreed to the call for platooning (step S350). Next, the following vehicle determination unit 148 causes a determined vehicle to start traveling as the following vehicle FV (step S352). After the processing of step S352, the procedure proceeds to step S122 of FIG. 5. As described above, description of the processing of the present flowchart ends.

FIG. 10 is a flowchart which shows an example of processing of causing extended platooning vehicles to perform avoidance by steering using the platooning control unit 142 of the master vehicle MV. The platooning control unit 142 acquires information on a traveling environment from the preceding vehicle LV (step S354). Next, the platooning control unit 142 determines whether avoidance by steering is necessary (step S356). When it is determined that avoidance by steering is not necessary, the procedure performs step S354 again after a certain period of time elapses. When it is determined that avoidance by steering is necessary, the platooning control unit 142 causes platooning vehicles to increase the second distance D2 (step S358). Next, the platooning control unit 142 transmits an instruction to generate a steering target trajectory to the platooning vehicles (step S360). Next, the platooning control unit 142 causes the following vehicle FV to perform avoidance by steering (step S362).

Next, the platooning control unit 142 determines whether the following vehicle FV performs avoidance (step S364). When it is determined that avoidance is performed, the platooning control unit 142 causes the platooning vehicles to change steering on the basis of the steering target trajectory (step S366). When it is determined that avoidance is not performed, the processing of step S364 is performed again after a certain period of time elapses.

After the processing of step S366, it is determined whether all the platooning vehicles have completed avoidance by steering (step S368). When it is determined that all the platooning vehicles have completed avoidance by steering, the platooning control unit 142 ends the processing. When it is determined that all the platooning vehicles have not completed avoidance by steering, the procedure performs the processing of step S368 again after a certain period of time elapses. As a result, the processing of the present flowchart ends.

[Processing Flow 4. Replacement of Following Vehicle]

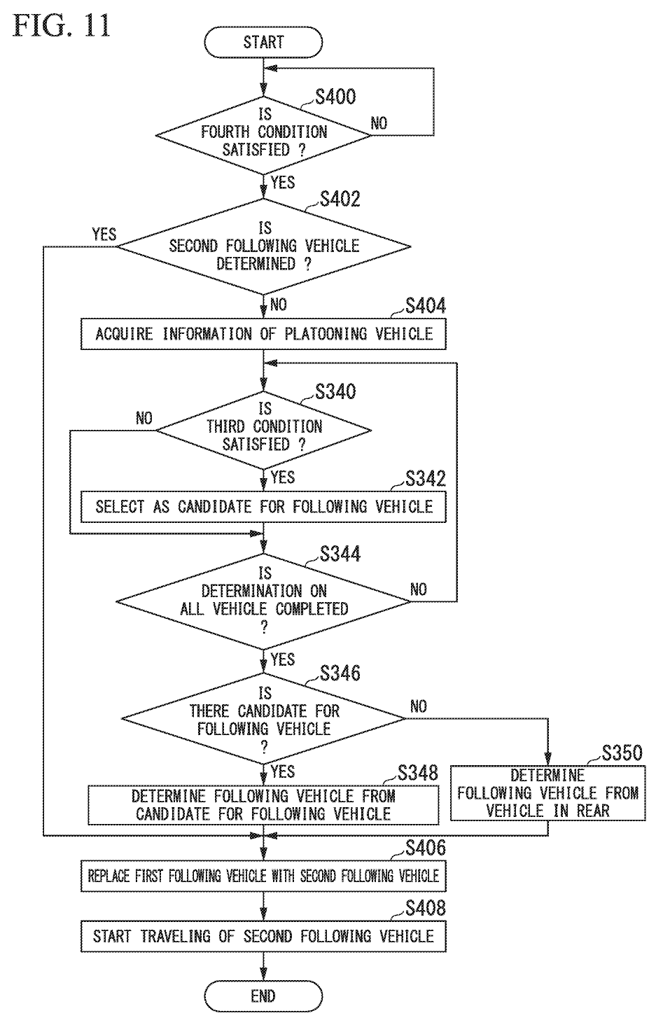

Next, an example of processing of replacing the following vehicle FV using the master vehicle MV will be described with reference to FIG. 11. FIG. 11 is a flowchart which shows an example of processing of replacing the following vehicle FV using the platooning control unit 142 and the following vehicle determination unit 148 of the master vehicle MV. Since a flow of processing of determining a second following vehicle performs the same processing as step S340 to step S350 of the flowchart shown in FIG. 9, processing of step S400 to step S408 will be mainly described in the following description.

The following vehicle determination unit 148 determines whether a first following vehicle satisfies a fourth condition (step S400). When it is determined that it does not satisfy the fourth condition, the processing of step S400 is performed again after a certain period of time elapses. When it is determined that it satisfies the fourth condition, the following vehicle determination unit 148 determines whether a second following vehicle has been already determined (step S402). When it is determined that the second following vehicle has not been already determined, the following vehicle determination unit 148 acquires information on platooning vehicles (step S404), performs the processing of steps S340 to S350, and performs processing of step S406. When it is determined that the second following vehicle has been already determined, the processing of step S406 is performed.

The platooning control unit 142 replaces the first following vehicle with the second following vehicle determined by the following vehicle determination unit 148 (step S406), and causes a traveling of the second following vehicle to start as the following vehicle FV (step S408). As a result, processing of the present flowchart ends.

According to the second embodiment as described above, in addition to the same effect as in the first embodiment, the platooning control unit 142 disposes a following vehicle FV traveling in the rear in the traveling direction of the platooning vehicles, and thereby the following vehicle FV can secure a space required for avoidance by steering of platooning vehicles when it is determined that avoidance by steering of platooning vehicles is necessary to be performed, and it is possible to continue more preferred control of extended platooning.

In the embodiments described above, description is provided using an example in which the master vehicle MV is a fixed vehicle, but the master vehicle MV may be replaced halfway. The master vehicle MV may serve as a role of the preceding vehicle LV or may serve as a role of the following vehicle FV. When the master vehicle MV serves as the role of the preceding vehicle LV or the role of the following vehicle FV, a vehicle equipped with the vehicle system 1 or a similar system may be charged for a part of a role of the master vehicle MV among platooning vehicles (for example, determination processing of selecting a next preceding vehicle LV or following vehicle FV).

In the embodiments described above, extended platooning may be performed by the same vehicle group from the start to the cancellation, and there may be an increase or decrease in the number of platooning vehicles after platooning is started. In this case, the platooning control unit 142 performs, for example, processing of selecting a preferred preceding vehicle LV and a preferred following vehicle FV in a new vehicle group whenever there is an increase or decrease in the number of platooning vehicles, and rebuilds a row.

[Hardware Configuration]

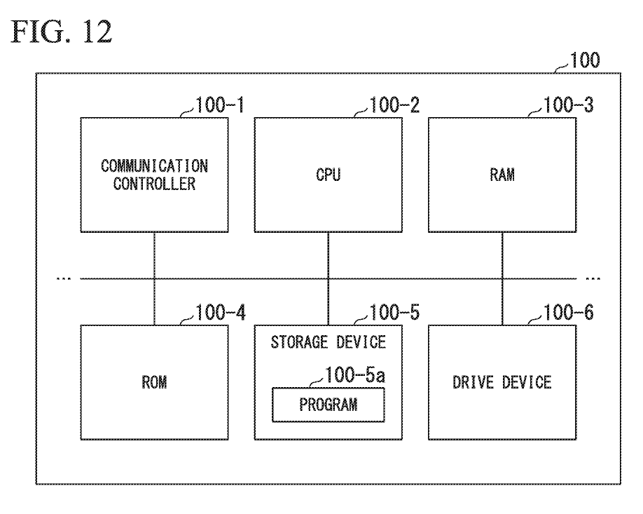

FIG. 12 is a diagram which shows an example of a hardware configuration of the automatic driving control device 100 according to the embodiment. As illustrated, the automatic driving control device 100 is configured to include a communication controller 100-1, a CPU 100-2, a random access memory (RAM) 100-3 which is used as a working memory, a read only memory (ROM) 100-4 which stores a boot program and the like, a storage device 100-5 such as a flash memory or an HDD, a drive device 100-6, and the like, which are connected to one another by an internal bus or a dedicated communication line. The communication controller 100-1 communicates with a component other than the automatic driving control device 100. The storage device 100-5 stores a program 100-5a executed by the CPU 100-2. This program is developed in the RAM 100-3 by a direct memory access (DMA) controller (not shown), and the like, and executed by the CPU 100-2. As a result, some or all of the first control unit 120 and the second control unit 160 are realized.

The embodiments described above can be expressed as follows.

A vehicle control device configured to include a storage device in which a program is stored and a hardware processor, in which the hardware processor executes a program stored in the storage device, thereby communicating with other vehicles, and determining that a host vehicle and the other vehicles are separated into platooning vehicles performing platooning and a preceding vehicle preceding the platooning vehicles by a distance larger than an inter-vehicle distance between the platooning vehicles and travel on the basis of a communication result of the other vehicle, and notifying the other vehicles of a result of the determination.

As described above, although embodiments for carrying out the present invention have been described, the present invention is not limited to these embodiments, and various modifications and substitutions can be made within a scope not deviating from the gist of the present invention.

What is claimed is:

1. A vehicle control device which includes a communication unit that communicates with other vehicles and a platooning control unit that performs control such that a host vehicle and the other vehicles perform platooning on the basis of a result of the communication with the other vehicles by the communication unit, further comprising:
a determination unit that selects one or more vehicles satisfying a first condition as a preceding vehicle among platooning vehicles, and determines that the one or more vehicles separately travel as a preceding vehicle preceding the platooning vehicles by a distance larger than an inter-vehicle distance between the platooning vehicles.

2. The vehicle control device according to claim 1,
wherein the first condition is that a vehicle is an unmanned automatic driving vehicle.

3. The vehicle control device according to claim 1,
wherein the first condition is that a vehicle has a higher external recognition performance than a reference.

4. The vehicle control device according to claim 1,
wherein, when the preceding vehicle satisfies a second condition, the determination unit determines a second preceding vehicle to replace the preceding vehicle as a next preceding vehicle among the platooning vehicles.

5. The vehicle control device according to claim 4,
wherein the second condition includes that a predetermined time has elapsed since the preceding vehicle started traveling as the preceding vehicle or that the preceding vehicle has traveled a predetermined distance or more since it started traveling as the preceding vehicle.

6. The vehicle control device according to claim 1,
wherein the determination unit determines each inter-vehicle distance between the platooning vehicles on the basis of whether an occupant is present in each of the platooning vehicles among the platooning vehicles.

7. The vehicle control device according to claim 1,
wherein the determination unit determines a deceleration of each of the platooning vehicles on the basis of whether an occupant is present in each of the platooning vehicles among the platooning vehicles.

8. The vehicle control device according to claim 1,
wherein the determination unit selects one or more vehicles satisfying a third condition among the platooning vehicles on the basis of a result of communicating with the other vehicles using the communication unit, and determines that the one or more vehicles become a following vehicle following the platooning vehicles by a distance larger than the inter-vehicle distance between the platooning vehicles.

9. The vehicle control device according to claim 8,
wherein, when a lane on which all the platooning vehicles travel is changed, the determination unit determines to perform a lane change from the following vehicle.

10. The vehicle control device according to claim 8,
wherein the third condition is that a vehicle is an unmanned automatic driving vehicle.

11. The vehicle control device according to claim 8,
wherein the third condition is that a vehicle has a higher external recognition performance than a reference.

12. The vehicle control device according to claim 8,
wherein, when the following vehicle satisfies a fourth condition, the determination unit determines a second following vehicle to replace the following vehicle as a next following vehicle among the platooning vehicles.

13. The vehicle control device according to claim 12,
wherein the fourth condition is that a predetermined time has elapsed since the following vehicle started traveling as the following vehicle or that the following vehicle has traveled a predetermined distance or more since the following vehicle started traveling as the following vehicle.

14. A vehicle control method of a computer comprising:
communicating with other vehicles;
performing control such that a host vehicle and the other vehicles perform platooning on the basis of a result of communicating with the other vehicles; and
selecting one or more vehicles satisfying a first condition as a preceding vehicle among platooning vehicles, and determining that the one or more vehicles separately travel as the preceding vehicle preceding the platooning vehicles by a distance larger than an inter-vehicle distance between the platooning vehicles.

15. A computer readable non-transitory storage medium in which a program is stored causes a computer to
communicate with other vehicles;
perform control such that a host vehicle and other vehicles perform platooning on the basis of a result of communicating with the other vehicles; and
select one or more vehicles satisfying a first condition as a preceding vehicle among platooning vehicles, and determine that the one or more vehicles separately travel as the preceding vehicle preceding the platooning vehicles by a distance larger than an inter-vehicle distance between the platooning vehicles.
